(19) United States
(12) Patent Application Publication
(10) Pub. No.: US 2020/0353562 A1
(43) Pub. Date: Nov. 12, 2020

(54) SYSTEM AND METHOD FOR MEASURING FOCUS POSITION OF HIGH-POWER LASER

(71) Applicant: Xi'an University of Technology, Xi'an (CN)

(72) Inventors: Xinmei Wang, Xi'an (CN); Shenjiang Wu, Xi'an (CN); Zebin Zheng, Xi'an (CN); Xuyang Liu, Xi'an (CN); Bin Wu, Xi'an (CN); Xinyu Wu, Xi'an (CN); Yingbao Fan, Xi'an (CN); Mingwei Lai, Xi'an (CN); Jinyu Wei, Xi'an (CN); Tianzhi Gao, Xi'an (CN)

(73) Assignee: Xi'an University of Technology, Xi'an (CN)

(21) Appl. No.: 16/869,736

(22) Filed: May 8, 2020

(30) Foreign Application Priority Data
May 9, 2019 (CN) 201910385191.0

(51) Int. Cl. B23K 26/0622; B23K 26/046; B23K 26/08

(52) U.S. Cl. CPC B23K 26/0624; B23K 26/0884; B23K 26/046

(57) ABSTRACT

A system and a method for measuring the focus position of high-power laser are disclosed. The system includes a micro-controller, a stepping motor driver, an electric lifting platform, an electric rotation platform, a metal target, a displacement sensor, a photoelectric sensor and an ADC module. The system uses a laser to irradiate the metal target, which is moved upward and downward, to obtain the best ablation point through the ultraviolet radiation emitted on it.

### TECHNICAL FIELD

The invention belongs to the technical field of laser parameter measurement equipment, in particular related to a system and a method for measuring the focus position of a high-power laser.

### BACKGROUND TECHNOLOGY

In recent years, laser engraving and cutting technology has been widely used in industrial processing. With the development of technology, the precision of material processing is required to be higher and higher in industry, and the precision of laser processing is closely related to the focus position of laser, therefore, it is the key technology for improving the precision of material processing that the focus position of laser is found accurately.

At present, in the field of laser processing, there are four main methods for measuring the focus position of laser:

1. Beam imaging method: in this method, the image of the spot caused by laser beam to be measured is obtained by using a Charge Coupled Device (CCD) camera, and the focus position of the laser beam is determined by means of judging the spot size at the different positions of the optical path. The measurement precision of this method is highly dependent on the resolution of CCD, and the CCD can not endure the direct irradiation of power laser beam. The closer to the focus of the beam, the more likely the CCD will be saturation or damaged. However, adding a light energy attenuator to the optical path of a high-power laser beam will lead to a large measurement error.

2. Direct measurement of laser beam energy distribution. The energy density is measured at the different positions of the optical path through the probe method or the knife edge method, and the maximum optical energy density is the focus of the beam. Its main limitation for applying is that the ablative damage of the probe or knife edge material will occur due to the heat accumulation under the intense laser irradiation. In order to reduce the measurement error, the measurement should be done as close to the beam focus as possible and the measuring time or the frequency should be increased, which means more serious ablative damage to the probe or the knife used. Hence, this method is not suitable for the precise focus positioning of high-power laser.

3. Ablation crater observation method. It uses an imaging equipment to take photos of the ablation crater traces on a laser target at the different positions of the optical path. The depths and the widths of the traces are compared by a complex image-processing algorithm for obtaining the focus position. The scorch and the slag generated by the ablation greatly influence the precision of the 3D ablation information from a high-resolution 3D image equipment such as a confocal microscopy operating in constant temperature and humidity environment. Hence, the method is much complex and high cost for obtaining a set of accurate measurement data.

4. Laser-induced air ionization observation method. In U.S. Pat. No. 6,303,903 B1, a method and a device are proposed for locating the surface of work piece used in laser processing. The method requires a CCD camera to take the “visible plasma spark” image produced by the air ionization at the focus of an ultra-short pulse laser. The method is fit only for the laser beams of which the focus have enough optical energy density to make the air ionized and sparked, such as a femtosecond power laser. Moreover, the method is not enough precise especially considering of the air ionizing randomness influenced by the environment around.

Thus, none of the existing methods can achieve the precise measuring of the focus position of high-power laser.

### CONTENTS OF INVENTION

The purpose of the invention is to provide a system and a method for measuring the focus position of high-power laser, and solve the problem that the existing method can't measure the focus position of high-power laser at low cost, automatically and accurately.

It is necessary to note that, the “focus” of the laser beam across focusing lens referred to in the invention means the best-ablation-effect position rather than the optical focus, considering of the high temperature effect. In the invention the “photoelectric response waveform”, (1) represents the electrical pulse waveform outputted by the photoelectric sensor when ablating the target for a short fixed duration, if the laser beam measured is from a continuous or a quasi-continuous laser; (2) represents the electrical pulse waveform outputted by the photoelectric sensor when ablating the target with a laser pulse, if the laser beam measured is from a giant-pulse laser with a low repetition frequency.

The biggest difficulty of positioning the high-power laser focus lies in that illuminating directly any costly measurement instrument using a high-power laser leads to a thermal damage, such as positioning the focus of a nanosecond pulsed laser with an average optical power of greater than 15 W using the existing methods listed above. Furthermore, because the laser is of monochromatic light, the laser energy can not be attenuated by filters, and there are non-ignorable measurement errors if adding other sorts of high-power attenuators in the optical path in front of the measurement instrument.

After a large number of studies, the inventors of this application found that: even using an indirect method of measuring the light excited by the high-power laser ablating on a metal targets, the light pulses are still too intensive for a CCD imaging equipment. Especially when the target is nearby the laser focus, a lot of effective information will be lost due to the oversaturation effect, which means a low measurement precision or even a costly equipment damage. Moreover, the CCD must be work with a low repetition frequency due to the thermal inertia of the target and the full-spectrum response characteristic of the CCD, which means it will take a long time to find the focus position.

In addition, in order to avoid the shape distortion caused by the laser ablation, the target must be thick enough, which results in a large thermal inertia of the target material. As for the photoelectric sensor made of other traditional semiconductor materials, the intrinsic absorption limits of them are at the infrared band, which means: 1) they can not be used to the 532-nm-wavelength and the 800-nm-wavelength lasers which are common used in industry, because the reflected light of the laser to be tested on the surface of the target will interfere with the photoelectric sensors to obtain effective information; 2) the sensors will respond to the photons of the infrared band so that the output photoelectric response waveform will be seriously constrained by the thermal inertia of the target, inducing the photoelectric response waveform presents three characteristics that are not conducive to the realization of fixed focusing function: a. large direct component (leading to a response saturation or an even device overheat failure), b. gentle peak (leading to a low focusing precision) and c. long trailing time (leading to a slow focusing measurement speed).

The inventors found that the higher the plasma temperature, the higher the plasma radiation intensity is, when a target is irradiated by a laser beam. The duration of the plasma ultraviolet emission is just a small part of the whole duration of the target lighting since the plasma dissipation is very fast and can be accelerated with high-speed inert gases. Furthermore, the inventors found that, after the high-power laser irradiates the metal targets there is not only the thermal radiation light emission of visible-infrared band, but also the light emission of ultraviolet band brought by the plasma of the target metal vaporization. Specifically, as shown in FIG. 1, the inventors noticed that the main spectral lines of the iron (Fe) plasma are almost in the shallow-ultraviolet band which is more easily tested than the deep-ultraviolet band of other common metal such as the copper (Cu) plasma.

The inventors also found that the third generation photoelectric sensor made of wide band-gap semiconductor has the characteristic of solar-blind (i.e., it only responds to ultraviolet light), therefore, its photoelectric response waveform has a narrow pulse width and an obvious peak, and it is not interfered by ambient temperature, daily light source and other factors, which is more suitable for the precise focusing of high-power laser.

Furthermore, the inventors noticed that the GaN (belongs to wide bandgap semiconductors) photodiodes have the photoelectric response only in the ultraviolet band, and the response spectrum of a typical GaN photodiode, as shown in FIG. 2, is just agree with the radiation spectrum of the Fe plasma. It is necessary to note that although SiC is also a wide bandgap semiconductor, SiC photodiode is obviously unfit in the present invention, considering that the carrier lifetime of SiC is far longer (about 1000 times) than that of GaN due to that GaN is of direct band gap but SiC is not. Hence, GaN sensors have a higher repetition frequency and a better linearity.

That is, the characteristic of the GaN photodiode is perfectly matched with the ultraviolet radiation of a Fe target caused by laser beam irradiation.

Thus, after a large number of failed attempts, the inventors of this application have finally found a high-speed precision method of high-power laser focus measurement.

In one aspect, the invention provides a system for determining the focus position of a high-power laser, wherein, it includes a micro-controller, a stepping motor driver, an electric lifting platform, an electric rotating platform, a metal target, a displacement sensor, a photoelectric sensor and an ADC module,

the micro-controller is used to control the stepping motor driver to drive the electric lifting platform to carry out stepping lifting and control the electric rotating platform to carry out stepping rotation;

the metal target is arranged on the electric rotating platform and is enabled to rotate together with the electric rotating platform;

the photoelectric sensor is arranged above the metal target, and the photoelectric sensor is used to measure the ultraviolet radiation emitted from the metal target and to generate an analog signal;

the ADC module is connected with the optoelectronic sensor and used for converting the analog signal to digital signal and transmitting the digital signal to the micro-controller,

wherein, during the measurement, the metal target is irradiated by laser beam emitted by the high-power laser; the micro-controller controls the electric rotation platform to rotate step by step and controls the electric lifting platform to move upward or downward, and then determines the ultraviolet radiation intensity received by the photoelectric sensor at each position; the micro-controller searches for the position where it has the maximum ultraviolet radiation intensity as the best ablation point, based on the data of ultraviolet radiation intensity at each position.

Preferably, the system also includes a displacement sensor arranged along the moving direction of the electric lifting platform and the displacement sensor used for measuring the lifting displacement of the electric lifting platform.

Preferably, the system also includes a first stepping motor and a second stepping motor in the electric lifting and the rotation platforms, respectively, wherein the first stepping motor is used for driving the electric lifting platform (5) upward and downward, and the second stepping motor is used to drive the electric rotation platform (6) to rotate.

Preferably, a signal amplifier is connected between the photoelectric sensor and the ADC module.

Preferably, the electric lifting platform includes a retractable sensor fixing device, which is used for fixing the photoelectric sensor.

Preferably, the photoelectric sensor (10) is a GaN photodiode and the metal target (7) is made of 304 stainless steel.

In another aspect, the invention provides a method for measuring the focus position of a high-power laser, using the system as above, wherein, including below steps:

Step 1: adjusting the electric lifting platform to move downward to a position obviously below the focus, and then adjusting the position of the photoelectric sensor to a position near the point to be irradiated by the high-power laser;

Step 2: performing the rough adjustment, wherein, it includes:
Step 2.1 turning on the high-power laser to emit a laser beam, so that the laser beam ablates the metal target to produce ultraviolet radiation signals;
Step 2.2 using the photoelectric sensor to acquire the ultraviolet radiation signals and convert the same into electric signals, wherein, the electric signals are converted into digital signals by means of the ADC module, and the digital signals are transmitted to the micro-controller;
Step 2.3 determining the value of the digital signal which representing the intensity of ultraviolet radiation, and when the value of the digital signal goes downward, driving the electric lifting platform continue to move upward a predetermined distance of L and stop;

Step 3 performing the fine adjustment, wherein, it includes:
Step 3.1 driving the electric lifting platform to move downward by a predetermined distance (D), and driving the electric rotation platform to rotate at a predetermined angle;

Step 3.2 acquiring ultraviolet radiation signal continuously while the laser beam is irradiating the metal target and converting the same into a group of digital signals; determining the maximum among the values of the group of digital signals measured at this position; calculating the average value of the background noise from the group of digital signals; and subtracting the noise average value from the maximum, the result of which is used as the measured value of the ultraviolet radiation signal at the current position.

Step 4 repeating the Step 3 until the metal target is obviously below the focus position and recording the measured value at each position of the electric lifting platform;

Step 5 determining a position at which the measured value is larger than any other position as the focus position of the high-power laser.

Preferably, the Step 5 includes: making an ultraviolet signal intensity curve according to the measured values at each position, using the common cubic-spline interpolation method, finding the maximum signal value in the interpolated curve through an extremum searching algorithm, and the corresponding position is the focus position of the high-power laser.

Preferably, each step of the electric lifting platform moved downward in the Step 3 is less than 500 μm.

Preferably, the upward moving distance of L in the Step 2 is 0-4 mm.

The determination of cost-effective material for the target.

The target selection process is based on two main theories: (1) each element has its unique emission spectrum, and therefore, the composition of the target material determines the proportion of the ultraviolet component of the plasma emission; (2) the intensity of the ultraviolet radiation is related to the plasma concentration, therefore, it is related to the melting point, specific heat capacity and thermal conductivity of the target material. Since the target of the invention is consumable, the target material shall have the advantages of high positioning precision, low material cost, high chemical stability, reasonable hardness (easy polishing processing) and low reflectivity (avoiding harm to the laser source or personnel caused by a strong reflection of the laser measured), etc. Finally, the inventors found that the 304 stainless steel is a very suitable material for the target to be irradiated.

The technical effects of the invention are as follows:

The system of the invention utilizes the solar-blind characteristic of a specific photoelectric sensor (a photodiode made of GaN) and only responds to the ultraviolet light within a full spectrum, so that it will not be out of action for unable to bear the light intensity, and is not affected by the lighting source, ambient temperature and other factors. The GaN photodiode can be used for positioning the focus of a high-power laser with a wavelength of visible-band or infrared-band. Moreover, in the invention, a stainless-steel target with high ultraviolet radiation intensity, high storage stability and low production cost is selected to ensure the accurate measurement of the focus position; and the system of the invention has a simple structure, low cost and high automation.

The measuring method of the invention is based on the principle that when a laser beam irradiates a metal target, the plasma produced by laser ablation will generate ultraviolet radiation signal, and the signal values at different positions will be acquired by the micro-controller to deduce the focus position of the laser.

### BRIEF DESCRIPTION OF DRAWINGS

FIG. 1 shows the plasma radiation spectrum of Cu, Fe and Al

FIG. 2 shows the photoelectric response characteristic curve of a typical GaN photodiode (Model GUVA-S12SD)

FIG. 3 shows a structural schematic diagram of the system for measuring the focus position of a high-power laser;

FIG. 4 shows a schematic diagram of a system circuit used for measuring the focus position of a high-power laser;

FIG. 5 shows a schematic diagram explaining the photoelectric information conversion relationship of the system used for measuring the focus position of a high-power laser;

FIG. 6 shows a schematic diagram of the ultraviolet-radiation-signal acquisition and amplification circuit in the embodiment of the invention.

FIG. 7 shows a distribution and occurrence sequence of the ablation traces in the embodiment of the invention

FIG. 8 shows the comparison of the focus position curves obtained by the method of the invention and by the ablation depth observation method of confocal microscopy.

FIG. 9 shows the measured signals achieved by the micro-controller, which is approximately proportional to the laser power.

FIG. 10 shows the typical morphology of an ablation trace under a confocal microscope.

FIG. 11 shows the radiation intensity comparison chart of a stainless steel, a copper and an aluminum targets ablated by a 1064-nm-wavelength laser.

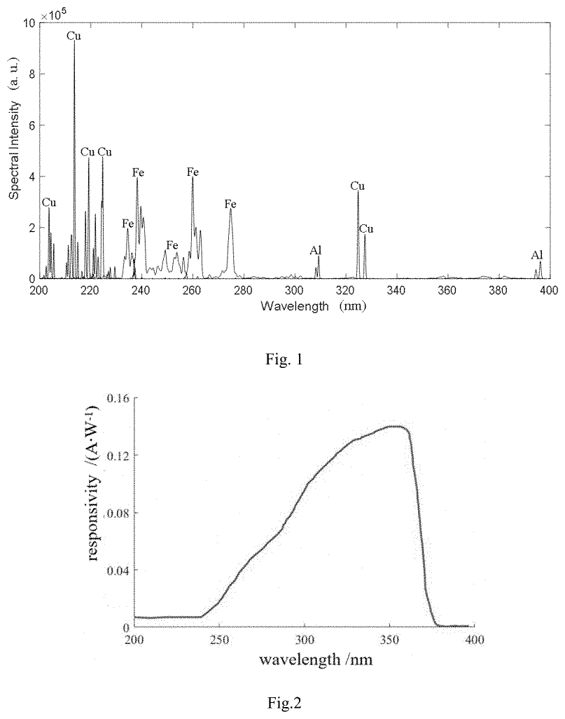

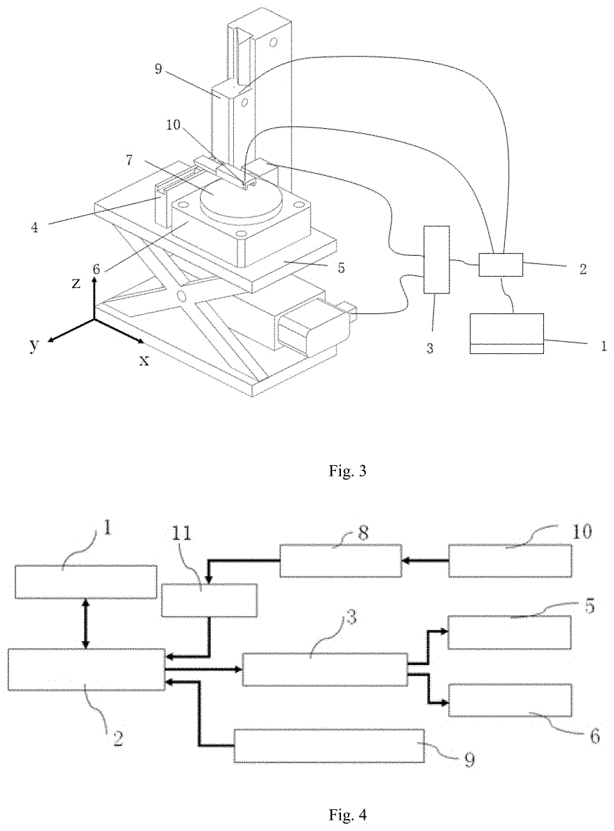

### FIGURE MARKS

1. User interface,

2. Micro-controller,

3. Stepping motor driver,

4. Fixing structure for Sensor,

5. Electric lift platform,

6. Electric rotating platform,

7. Metal target,

8. Signal amplifier,

9. Grating scale displacement sensor,

10. Photoelectric sensor,

11. ADC module,

13. Laser source,

14. Laser beam

### Specific Embodiment Mode

The present invention will be described in detail in combination with the attached figures and the specific embodiment.

In the embodiment, a system for measuring the focus position of the high-power laser is provided. As shown in FIG. 3, it comprises a user interface 1, a micro-controller 2, a stepping motor driver 3, the stepping motor driver 3 respectively connected with an electric lifting platform 5 and an electric rotating platform 6 located on the electric lifting platform 5, a metal target 7 on the electric rotating platform 6 and a photoelectric sensor 10 above the metal target 7, and the photoelectric sensor 10 connected to the ADC module 11, which is used to acquire electrical signals.

The user interface 1 is utilized to set and show the parameters of the system, and includes starting button and the information of the focus position and the like, which can be realized by an ordinary computer.

Preferably, the system also includes a displacement sensor 9 (for example, grating ruler displacement sensor) arranged along the moving direction of the electric lifting platform 5 to measure the actual moving distance of the lifting platform 5. The displacement sensor 9 and an analog-to-digital conversion (ADC) module 11 are connected to the micro-controller 2, which calibrates the lifting amplitude of the electric lifting platform 5 according to the displacement feedback signal acquired by the displacement sensor 9.

As shown in FIG. 4, the photoelectric sensor 10 acquires the ultraviolet radiation signal and converts it into a corresponding electrical signal. The signal amplifier 8 is connected between the photoelectric sensor 10 and the ADC module 11, which is used to amplify the electrical signal output from the photoelectric sensor 10. Finally, the analog signal is converted into digital signal by the ADC module 11 and transmitted to the micro-controller 2.

Preferably, the electric lifting platform 5 is also connected with a retractable sensor fixing device 4, which is retractable and can move left and right. The retractable sensor fixing device 4 can be used to fix and move the photoelectric sensor 10 to any position above the surface of the metal target 7, so as to suitably receive the ultraviolet radiation and avoid the signal too weak or the signal distortion due to saturation.

The surface of the metal target 7 is smooth and flat, and is fixed on the electric rotating platform 6; the electric rotating platform is driven by the stepping motor driver 3 controlled by the micro-controller 2, and the laser spot on the metal target 7 can be adjusted, so that the characteristics of the surface of the metal target 7 are consistent during each time of ablation, so as to reduce the random error; and the electric rotating platform 6 is fixed on the platform of the electric lifting platform 5 which is driven by the stepping motor driver 3 controlled by the micro-controller 2, and can move upward and downward in the z direction.

The electric lifting platform 5 has a stepping lifting motor inside, which is used to drive the electric lifting platform 5 up and down. The electric rotating platform 6 is provided with a stepping rotating motor inside, which is used to realize the rotating movement of the platform and the target thereon.

As shown in FIG. 3, the lowest horizontal position of the system is set as the origin in the z direction.

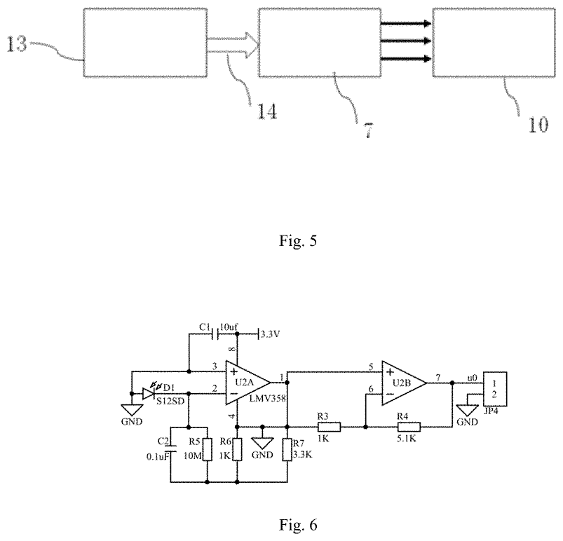

As shown in FIG. 5, the measurement system is operated in the following manner, i.e. the following method is used for measurement, which includes:

Step 1: By means of the user interface 1, adjusting the electric lifting platform 5 to move downward to a position obviously lower than focus position, and adjusting the position of the photoelectric sensor 10 to a position near the laser irradiation;

Step 2: Rough adjustment: setting the upward movement distance of the electric lifting platform 5, and turning on the laser source 13 to emit the laser beam 14. The laser beam 14 ablates the central position of the metal target 7 to generate ultraviolet radiation. The photoelectric sensor 10 acquires the ultraviolet radiation, converts it into a photoelectric response waveform, and transmits the waveform information to the micro-controller 2 through the ADC module 11. The micro-controller 2 extracts the peak value of the waveform and compares it with the peak value of the previous waveform. As soon as the micro-controller 2 determines that the peak value starts to decline, it means that the focus position has just passed, and the electric lifting platform 5 continues to move upward for a distance of L and then stops. At this point, the metal target 7 is located above the laser focus and the rough adjustment stage is over.

The upward moving distance of L can be set as 0.1-4 mm.

Step 3: Adjusting the ablating position of the laser beam 14, so that the ablation trace can be located near the inner edge of the metal target 7, so as to prepare for the following fine adjustment;

Step 4: The micro-controller 2 saves the current height coordinate of the metal target 7 and controls the laser source 13 to emit the laser 14 for ablating a trace on the metal target 7 to generate ultraviolet radiation. The photoelectric sensor 10 acquires the ultraviolet radiation and converts it into a photoelectric response waveform. The waveform information is transmitted to the micro-controller 2 through ADC module 11. The micro-controller 2 extracts the peak value of the waveform, saves it, and, at the same time, controls the electric rotating platform 6 to rotate an angle to ensure that the new ablation trace does not cover the previous ablation trace. In order to reduce the random error, this Step 4 will be repeated for N times, and the micro-controller 2 finally preserves a mean value of the N measurements. The repetition times N may be 1-10.

The micro-controller 2 controls the electric lifting platform 5 to move downward by a fine distance D, and repeats the Step 4 until the total downward travel of the electric lifting platform 5 is more than 2 L;

Preferably, each time, the rotation angle θ of the electric rotating platform 6 should be greater than 20°.

Preferably, in order to make the best use of the target, an approximate value of an irrational number can be selected for the rotation angle of θ. Based on mathematical common knowledge, the arithmetic sequence formed with the irrational number interval has no any periodicity. With the irrational number of greater than 20° it is possible to ablate more non-overlapping ablation traces under the premise of the heat dissipation of the metal target 7.

Preferably, when the electric lifting platform 5 is moved step by step, the displacement sensor 9 measures the actual displacement information of the electric lifting platform 5, and the displacement information is fed back to the micro-controller 2 so that the micro-controller 2 calibrates the moving step number according to the displacement information to solve the step-missing problem of the electric lifting platform 5 under an electromagnetic interference working condition.

Preferably, for the photoelectric response waveform obtained in the Step 3, if there are lots of burrs in the waveform, in order to reduce the peak judgment error, the micro-controller 2 can execute the sliding average filtering algorithm to filter the photoelectric response waveform signal.

In the Step 5, according to the data set saved in the Step 4, the relationship between the z-coordinate values and the peak values of ultraviolet photoelectric response is analyzed by the micro-controller 2 based on the conventional mathematical algorithm, and then the z-coordinate position information of the laser focus is obtained and displayed on the user interface 1.

Preferably, the mathematical algorithm is as follows: at first, the cubic spline method is used to interpolate in the measured data set, then the maximum value in the interpolation curve is found through the extremum search algorithm, and the corresponding position of the maximum value is the focus position of the laser beam.

### EXAMPLE

A GSS-FIB-20 laser engraving machine is adopted in this example, the laser wavelength of which is 1,064 nm, the beam quality is M²<2, and the minimum line width is 0.01 mm. The photoelectric sensor of the invention adopts a GaN Schottky diode (e.g. the GUVA-512513), and the signal amplifier adopts a semiconductor chip LMV358; the metal target adopts a 304 stainless steel plate with smooth surface, and the thickness of the steel plate is 8 mm; the micro-controller adopts STM32F407ZGT6, the ADC module adopts an ADC module attached inside the STM32F407ZGT6; the stepping motor driver adopts DM432C; and the displacement sensor adopts a grating scale displacement sensor SINOKA300.

Firstly, when testing is started, using the user interface to control the electric lifting platform move downward and adjust the plane to a lower position. Then, turning on the laser engraving machine system, and setting the laser engraving machine's light average power to 5 W, repetition frequency to 20 kHz, duration of each outputting laser pulse sequence to 21 ms and ablation trace to a 5-mm-length straight line.

Then, performing the rough adjustment process, in which L=2 min, and performing the fine adjustment process, in which the number N of repetitions is 10. The ADC module acquisition system circuit is shown in FIG. 6. Since it is found that the burrs near the peak are obvious, each waveform is subject to smoothing filter processing. After each time of signal acquirement, the electric rotating platform rotates counterclockwise, wherein, the angle of θ=79.54951°, which is the approximate value of the irrational number

$$\frac{180}{1.6 \sqrt{2}} .$$

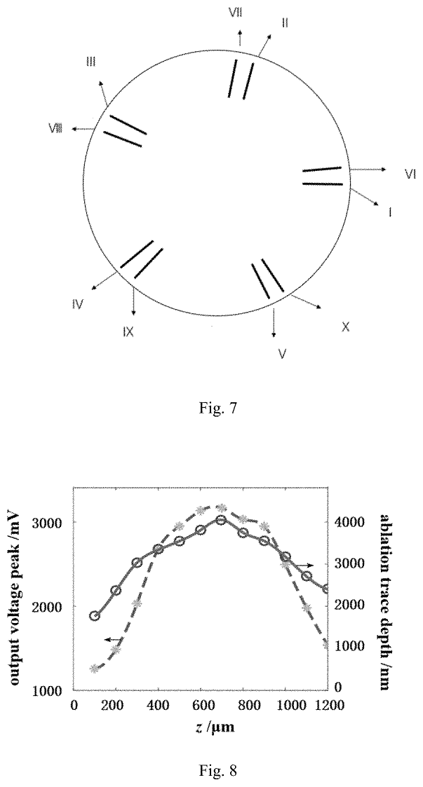

FIG. 7 is the schematic diagram of the position and occurrence sequence of the traces.

According to the Step 5, all of the measured data are interpolated with the cubic spline method by the micro-controller, and the obtained curve is shown in FIG. 8. The curve vertex is found through the extreme value search algorithm, and its vertex relative position is at 666 μm, which relative position is the focus position measured by the invention relative to a predetermined point.

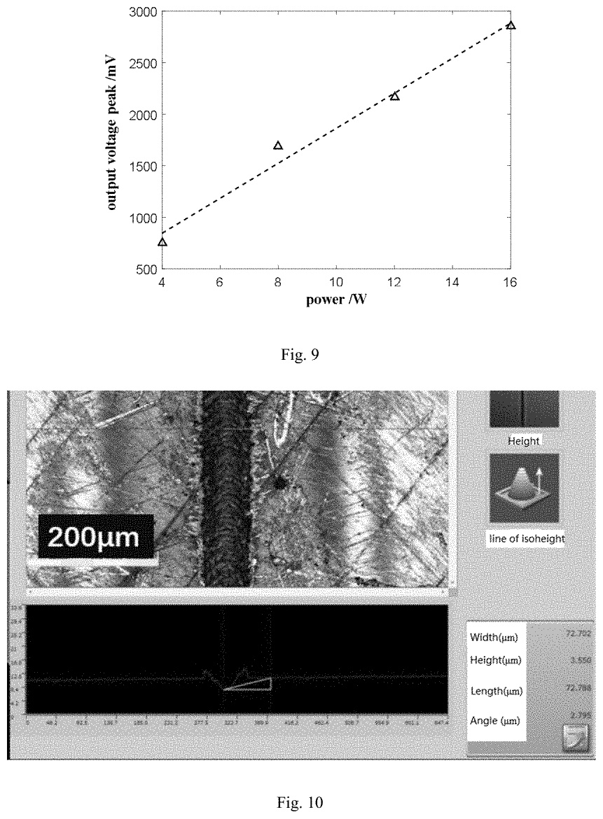

Increasing the laser power of the laser engraving machine from 4 W to 20 W when the target height is nearby the laser focus, the experimental results of FIG. 9 show that the signals achieved by the micro-controller is approximately proportional to the laser power. It means that the system and method of the present invention has a good linearity to ensure the laser focus positioning precision.

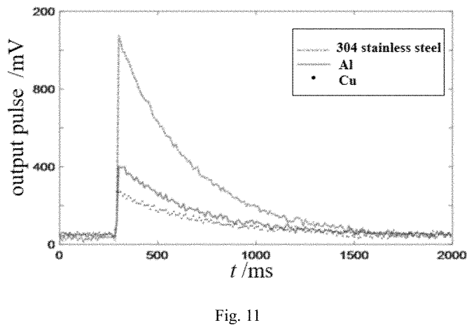

In order to prove the effectiveness of the system and measurement method of the present invention, the depth of each ablation trace was measured by an OLS4100 confocal microscope. The microcosmic morphology of a typical ablation trace under the microscope is shown in FIG. 10. Since each ablation trace is composed of a series of laser ablation pits, the average depth of 5 ablation pits in each ablation trace is calculated to reduce the observation error of the human eye as much as possible. Finally, the fitting curve of the average ablation depth was obtained as shown in FIG. 8, in which the curve vertices relative position is at 690 μm.

Compared with the vertex coordinates of the two curves in FIG. 8, the results obtained by the two methods are similar, and the difference between them is only 24 μm. In the present invention, the method is named as “method of observing ablation depth with confocal microscope”. It is worth pointing out that confocal microscopes are expensive, complicated, and time-consuming, therefore, the method based on a confocal microscope is only suitable for some scientific research and verification in constant-temperature constant-humidity dust-free environment laboratories.

In addition, the inventors noticed that there were some differences about the plasma ultraviolet luminescence performance among the targets made of different metal materials. Therefore, the inventors used the device shown in the embodiment to compare the ultraviolet photoelectric response curves of the stainless steel, the pure copper, the pure aluminum and other conventional metals under the same laser condition. As shown in FIG. 11, it was found that the stainless steel has the best signal sensitivity. Considering the signal sensitivity, the material cost, the polishing cost, the oxidation resistance and the reflectivity, the optimal material of the target is stainless steel.

1. A system for determining the focus position of a high-power laser, including a micro-controller, a stepping motor driver, an electric lifting platform, an electric rotating platform, a metal target, a displacement sensor, a photoelectric sensor and an ADC module, wherein:
the micro-controller is used to control the stepping motor driver to drive the electric lifting platform to carry out stepping lifting and control the electric rotating platform to carry out stepping rotation;
the metal target is arranged on the electric rotating platform, and is enabled to rotate with the electric rotating platform;
the photoelectric sensor is arranged above the metal target, and the photoelectric sensor is used to measure the ultraviolet radiation emitted from the metal target and to generate an analog signal;
the ADC module is connected with the optoelectronic sensor and used for converting the analog signal to digital signal and transmitting the digital signal to the micro-controller;
during the measurement, the metal target is irradiated by laser beam emitted by the high-power laser;
the micro-controller controls the electric rotation platform to rotate step by step and controls the electric lifting platform to move upward or downward, so that the ultraviolet radiation intensity at each position is received by the photoelectric sensor; and
the micro-controller searches for the position where it has the maximum ultraviolet radiation intensity as the best ablation point, based on the data of ultraviolet radiation intensity at each position.

2. The system of claim 1, further comprising a displacement sensor arranged along the moving direction of the electric lifting platform and used for measuring the lifting displacement of the electric lifting platform.

3. The system of claim 1, further comprising a first stepping motor and a second stepping motor in the electric lifting and the rotation platforms, respectively, wherein the first stepping motor is used for driving the electric lifting platform upward and downward, and the second stepping motor is used to drive the electric rotation platform to rotate.

4. The system of claim 1, wherein, a signal amplifier is connected between the photoelectric sensor and the ADC module.

5. The system of claim 1, wherein, the electric lifting platform includes a retractable sensor fixing device, which is used for fixing the photoelectric sensor.

6. The system of claim 1, wherein, the photoelectric sensor is a GaN photodiode and the metal target is made of 304 stainless steel.

7. The system of claim 1, wherein, for each time of rotation, the electric rotation platform rotates a predetermined angle in the unit of ‘°’, the value of which is approximately equal to an irrational number bigger than 20.

8. A method for measuring the focus position of a high-power laser, using the system of claim 1, comprising:
Step 1: adjusting the electric lifting platform to move downward to a position obviously below the focus, and then adjusting the position of the photoelectric sensor to a position near the point to be irradiated by the high-power laser;
Step 2: performing the rough adjustment, the Step 2 further comprising:
Step 2.1 turning on the high-power laser to emit a laser beam, so that the laser beam ablates the metal target to produce ultraviolet radiation signals;
Step 2.2 using the photoelectric sensor to acquire the ultraviolet radiation signals and convert the same into electric signals, wherein, the electric signals are converted into digital signals by means of the ADC module, and the digital signals are transmitted to the micro-controller; and
Step 2.3 determining the value of the digital signal which representing the intensity of ultraviolet radiation and when the value of the digital signal goes downward, drives the electric lifting platform continue to move upward a predetermined distance of L and stop;
Step 3 performing the fine adjustment, the Step 3 further comprising:
Step 3.1, driving the electric lifting platform to move downward a predetermined distance, and driving the electric rotation platform to rotate at a predetermined angle; and
Step 3.2 acquiring ultraviolet radiation signal continuously while the laser beam is irradiating the metal target and converting the same into a group of digital signals; determining the maximum among the values of the group of digital signals measured at this position; calculating the average value of the background noise from the group of digital signals; and subtracting the noise average value from the maximum, the result of which is used as the measured value of the ultraviolet radiation signal at the current position;
Step 4 repeating the Step 3 until the metal target is obviously below the focus position and recording the measured value at each position of the electric lifting platform; and
Step 5 calculating out a position at which the ultraviolet radiation signal is larger than any other position regarded as the focus position of the high-power laser.

9. The method of claim 8, wherein, the Step 5 includes:
making an ultraviolet signal intensity curve according to the measured values at each position;
using the cubic-spline interpolation method to interpolate the measured values;
finding the maximum value in the interpolated curve through an extremum searching algorithm; and
the corresponding position is the focus position of the high-power laser.

10. The method of claim 8, wherein, the value of said predetermined angle in the unit of in the Step 3.1 is approximately equal to an irrational number bigger than 20.
